(19) United States
(12) Patent Application Publication
(10) Pub. No.: US 2024/0379090 A1
(43) Pub. Date: Nov. 14, 2024

(54) AUDIO SIGNAL PROCESSING METHOD AND APPARATUS

(71) Applicant: GAUDIO LAB, INC., Seoul (KR)

(72) Inventors: Minsung KANG, Seoul (KR); Sangshin OH, Seoul (KR); Hyeongi MOON, Seoul (KR); Kyungyun LEE, Seoul (KR); Keunwoo CHOI, Incheon (KR); Sangbae CHON, Seoul (KR); Sungmin KIM, Gyeonggi-do (KR)

(21) Appl. No.: 18/661,330

(22) Filed: May 10, 2024

Related U.S. Application Data
(60) Provisional application No. 63/521,336, filed on Jun. 15, 2023.

(30) Foreign Application Priority Data
May 12, 2023 (KR) 10-2023-0061838

(51) Int. Cl. G10L 13/02; G10L 25/27

(52) U.S. Cl. CPC G10L 13/02; G10L 25/27

(57) ABSTRACT

An audio signal processing device for generating an audio signal for an input modal is disclosed. The audio signal processing device includes a processor. The processor is configured to: acquire a label indicating the feature of a group to which the input modal belongs; concatenate the acquired label to the input modal; and input the input modal and the acquired label into a generative model to generate an audio signal.

### TECHNICAL FIELD

The present disclosure relates to an audio signal processing method and an audio signal processing device for generating an audio signal from input modality by using a machine learning model.

### BACKGROUND ART

With the development of artificial intelligence technologies such as large language models (LLMs) and generative artificial intelligence (GAI), a method for generating user-desired responses or data has been discussed in various field. In particular, multimodal language models or generative models that simultaneously process information from different modalities such as images and language have gained attention in recent years. Machine learning and artificial intelligence technologies are being applied not only to images and language, but also to audio signals. There are ongoing attempts to implement speech synthesis models that can understand the meaning of given audio signals, and classify audio signals or generate speech corresponding to given text. Speech synthesis models are being used not only to human speech, but also to generate ambient sounds, such as sounds from animals, objects, or nature.

For example, an audio signal processing device may use techniques such as variational autoencoders (VAEs) and generative adversarial networks (GANs) to generate audio signals that correspond to text. Variational autoencoder-based models may be categorized into an encoder model and a decoder model. The encoder model converts given data into a latent representation. The decoder model converts the latent representation to the given data. The distribution of latent representations converted using the encoder model is called a posterior distribution. The normal distribution, which allows for easy sampling, is often selected as the posterior distribution. When the audio signal processing device generates data by using a variational autoencoder model, the audio signal processing device takes a sample from the posterior distribution and converts the sample to data by using a decoder. During this process, training and generation process may be optimized by using statistical values from the posterior distribution or by using conditional input for the decoder.

On the other hand, a generative adversarial network is trained through a game between a generator and classifier. The generator produces a sample similar to a real data sample, and the classifier distinguishes between the generated sample and the real data sample. The generator is trained to make the classifier determine that the generated sample is the true data sample, based on the output of the classifier, that is, to fool the classifier.

### DISCLOSURE

### Technical Problem

An aspect of an embodiment of the present disclosure is to provide an audio signal processing method and an audio signal processing device for generating an audio signal from input modality by using a machine learning model.

### Technical Solution

In accordance with an embodiment of the present disclosure, an audio signal processing device for generating an audio signal for an input modal includes a processor. The processor is configured to acquire a label indicating a feature of a group to which the input modal belongs, concatenate the acquired label to the input modal, and input the input modal and the acquired label into a generative model to generate an audio signal.

The label may have a text form.

The processor may be configured to, in case that the audio signal processing device receives multiple input modals, independently concatenate a label corresponding to each of the multiple input modals to each of the multiple input modals.

The label may be text indicating the feature of the group indicated by the label.

The feature of the group indicated by the label may include at least one among quality reference information indicating a quality of the audio signal to be generated, recording environment information indicating a recording environment, or background sound information indicating whether the audio signal to be generated is background sound.

The feature of the group indicated by the label may include quality reference information. The processor may be configured to generate the audio signal by fixing the quality reference information a to predetermined quality.

Furthermore, the generative model may be trained using not only the predetermined quality, but also quality reference information indicating a quality other than the predetermined quality.

The input modal may include at least one among text indicating a category, text, text inferred from an image, or text inferred from a video.

The generative model may be configured to acquire tokens from the input modal and the label, generate a feature vector from the acquired tokens, generate an audio frequency characteristic from the feature vector, and synthesize an audio signal from the generated audio frequency characteristic.

The generative model may be configured to generate a first audio frequency characteristic, and generate, as the audio frequency characteristic, a second audio signal frequency characteristic having a higher resolution in at least one of a time axis or a frequency axis than the first audio frequency characteristic.

Skip connections and FiLM may be used when the generative model generates an audio frequency characteristic from the feature vector and synthesizes an audio signal from the generated audio frequency characteristic.

In accordance with an embodiment of the present disclosure, in a training method for an audio signal processing device for generating an audio signal for an input modal, the audio signal processing device is trained to acquire a label indicating a feature of a group to which the input modal belongs, concatenate the acquired label to the input modal, and input the input modal and the acquired label into a generative model to generate an audio signal.

The label may have a text form.

The audio signal processing device may be configured to, in case that the audio signal processing device receives multiple input modals, independently concatenate a label corresponding to each of the multiple input modals to each of the multiple input modals.

The label may be text indicating the feature of the group indicated by the label.

The feature of the group indicated by the label may include at least one among quality reference information indicating a quality of the audio signal to be generated, recording environment information indicating a recording environment, or background sound information indicating whether the audio signal to be generated is background sound.

The feature of the group indicated by the label may include quality reference information. The generative model may be trained using not only a predetermined quality, but also quality reference information indicating a quality other than the predetermined quality. Furthermore, when the audio signal processing device generates an audio signal after the training, the audio signal processing device may be configured to generate the audio signal by fixing the quality reference information to the predetermined quality.

The input modal may include at least one among text indicating a category, text, text inferred from an image, or text inferred from a video.

The generative model may be configured to acquire tokens from the input modal and the label, generate a feature vector from the acquired tokens, generate an audio frequency characteristic from the feature vector, and synthesize an audio signal from the generated audio frequency characteristic.

The generative model may be configured to generate a first audio frequency characteristic, and generate, as the audio frequency characteristic, a second audio signal frequency characteristic having a higher resolution in at least one of a time axis or a frequency axis than the first audio frequency characteristic.

Skip connections and FiLM may be used when the generative model generates an audio frequency characteristic from the feature vector and synthesizes an audio signal from the generated audio frequency characteristic.

### Effects of the Invention

An embodiment of the present disclosure may provide an audio signal processing method and an audio signal processing device for generating an audio signal from input modality by using a machine learning model.

### BRIEF DESCRIPTION OF THE DRAWINGS

FIG. 1 illustrates the structure of an audio signal processing device according to an embodiment of the present disclosure.

FIG. 2 illustrates a process in which a text input is processed by a text input unit and a text encoder according to an embodiment of the present disclosure.

FIG. 3 illustrates a process in which a modal encoder according to an embodiment of the present disclosure processes various types of inputs.

FIG. 4 illustrates an example of a machine learning device being trained in parallel according to an embodiment of the present disclosure.

FIG. 5 illustrates an example of a machine learning device being trained in series according to an embodiment of the present disclosure.

FIG. 6 illustrates the results of evaluating the performance of an audio signal processing device trained according to an embodiment of the present disclosure.

### DETAILED DESCRIPTION OF EMBODIMENTS OF THE INVENTION

Hereinafter, embodiments of the present disclosure will be described with reference to the accompanying drawings in detail so as to be easily implemented by those skilled in the art to which the present disclosure belongs. However, the present disclosure may be implemented in various different forms and is not limited to the embodiments described herein. In order to clearly describe the present disclosure in the drawings, parts not pertinent to the description have been omitted, and similar parts have been designated by similar drawing numerals throughout the specification. Furthermore, when a part is said to “include” an element, this implies that, unless specifically stated otherwise, the part may further include other elements, rather than excluding the other elements.

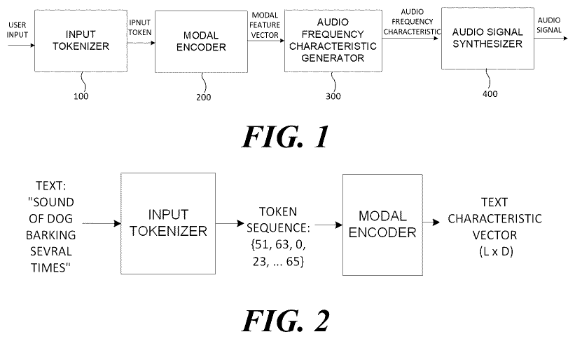

FIG. 1 illustrates the structure of an audio signal processing device according to an embodiment of the present disclosure.

An audio signal processing device according to an embodiment of the present disclosure may include an input tokenizer 100, a modal encoder 200, an audio frequency characteristic generator 300, and an audio signal synthesizer 400. These software functional blocks may be operated on one or more processors. In addition, the functional blocks may be divided into respective detailed modules.

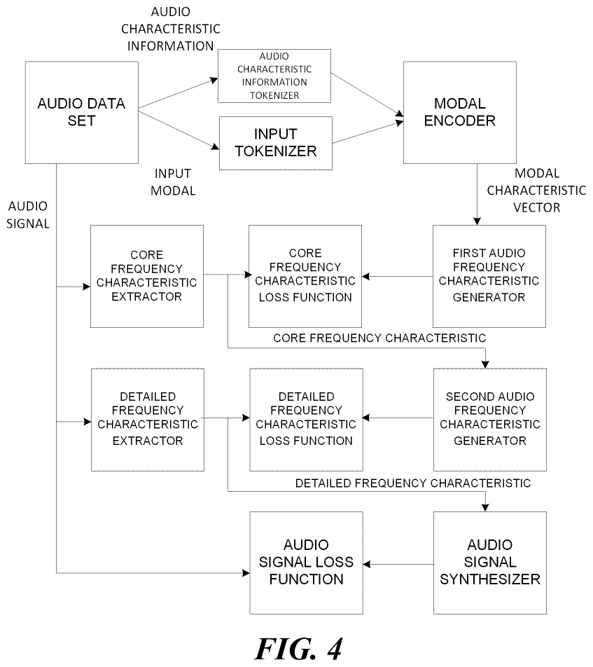

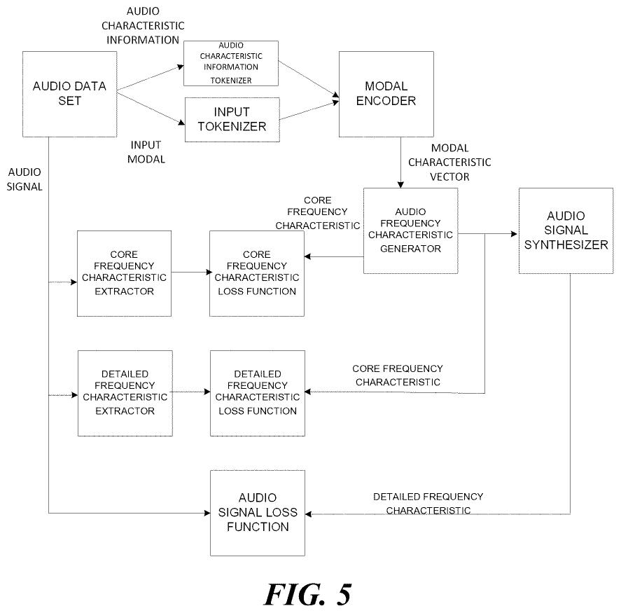

The input tokenizer 100 may acquire tokens from an input modal and an audio feature corresponding to the input modal. In this case, the audio feature corresponding to the input modal may be a label that will be described with reference to FIGS. 4 and 5. The modal encoder 200 generates a feature vector from the tokens. The input tokenizer 100 and the modal encoder 200 may include sub-modules for each type of input. For example, the input tokenizer 100 may include a text tokenizer and an image tokenizer. Furthermore, the modal encoder 200 may include a text encoder and an image encoder.

The audio frequency characteristic generator 300 may generate an audio frequency characteristic from a feature vector. The audio frequency characteristic generator 300 may be divided according to steps. For example, the audio frequency characteristic generator 300 may include a first generator and a second generator. The second generator may generate a frequency characteristic based on a frequency characteristic generated by the first generator. In this case, the frequency characteristic generated by the second generator may have a higher resolution than the frequency characteristic generated by the first generator. Specifically, the first generator may generate a core frequency context, and the second generator may generate detailed audio frequency characteristic based on the frequency context generated by the first generator. The modal encoder 200 may extract a modal feature vector by analyzing the meaning of an input modal that has been input by a user. The input modal may include at least one of text indicating a category, text, text inferred from an image, or text inferred from a video. The modal feature vector may embed information about an audio signal corresponding to the user's input and may be used as input to an audio frequency generator. Then, the audio frequency generator 300 generates audio frequency characteristics through a series of processes. The audio frequency characteristics may be input into the audio signal synthesizer to be synthesized in an audio signal form.

The input tokenizer 100 and the modal encoder 200 may process various user inputs. For example, the audio signal processing device may use the text tokenizer and text encoder to generate an audio signal corresponding to text that has been input by the user. FIG. 2 illustrates a process in which a text input is processed by a text input unit and a text encoder according to an embodiment of the present disclosure. The text input unit converts natural language text into a sequence of tokens through a tokenizing process. The converted token sequence is converted, through the text encoder, into a modal feature vector that can be processed by an audio frequency generator. The text tokenizer and the text encoder may also be used as submodules of another modal encoder. For example, when an image is input into the audio signal processing device, the image may be converted directly to a feature vector through an image input and an image encoder. In another specific embodiment, when an image is input into the audio signal processing device, the image may first be converted to text, and then the converted text may be converted into a feature vector through a text tokenizer and a text encoder.

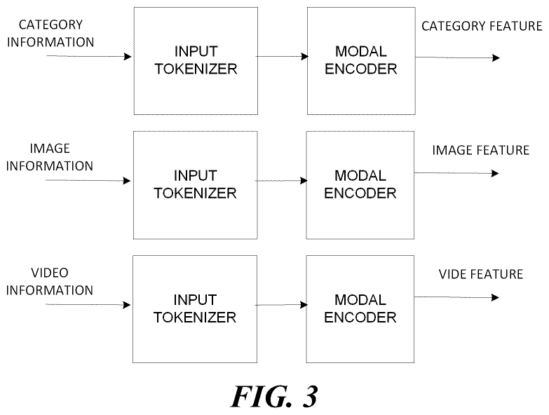

The modal encoder 200 may have various structures depending on the type of input. FIG. 3 illustrates a process in which a modal encoder according to an embodiment of the present disclosure processes various types of inputs. For example, a neural network layer that processes an input for category text information may have the form of a look-up table. A neural network layer that processes a general text input for generating more various audio signals may use a language model, such as a text-to-text transfer transformer (T5), a generative pre-trained transformer (GPT), or a large language model Meta AI (LLaMA). In another specific embodiment, the neural network layer that processes general text inputs for generating various audio signals may use a multimodal language model, such as a contrastive language-image pre-training (CLIP) or contrastive language-audio pre-training (CLAP). A neural network layer that processes an image or video input may use structure-based image encoders, such as masked auto-encoders (MAEs) or vision transformers (ViTs). In addition, the neural network layer that processes an image or video input may use an image captioning model or a multimodal language model for conversion into text. Non-linguistic modal information, such as category text, image, or video, may be processed directly through a tokenizer for non-linguistic modal information. In another specific embodiment, non-linguistic modal information may be converted to text through separate preprocessing and then input into the tokenizer.

The audio frequency characteristic generator 200 generates an audio frequency characteristic based on the input modal feature vector. As described above, the audio frequency characteristic generator 200 may generate the audio frequency characteristic in multiple steps. Thus, the audio signal processing device may efficiently generate an audio frequency characteristic and increase performance for generating the audio frequency characteristic. Specifically, the second generator of the audio frequency characteristic generator 200 may generate a frequency characteristic based on a frequency characteristic generated by the first generator. In this case, a frequency characteristic generated by the second generator may have a higher resolution than the frequency characteristic generated by the first generator in at least one of a time axis or a frequency axis. For example, the time unit of the frequency characteristic generated by the second generator may be smaller than the time unit of the frequency characteristic generated by the first generator. The frequency unit of the frequency characteristic generated by the second generator may be smaller than the frequency unit of the frequency characteristic generated by the first generator. In a specific embodiment, the first generator generates a core frequency characteristic in the overall context. The first generator may generate a core frequency characteristic in which core features of an overall signal and core changes in an audio frequency characteristic in the overall time axis are captured. The second generator may generate a detailed frequency characteristic by interpolating a detailed feature based on the core frequency characteristic and generating a detailed region. With these embodiments, in the audio signal processing device, the first generator may focus on generating a core characteristic without being immersed in a detailed characteristic, and the second generator may be used to complement an insufficient detailed characteristic to improve the quality of a generated sound source.

The audio signal synthesizer 400 may synthesize an audio signal from the generated frequency characteristics. The audio signal may be a time-series audio signal. In a specific embodiment, the audio signal synthesizer 400 may be a neural vocoder that converts a mel-spectrogram into a time-series signal. Typically, the length of an audio frequency characteristic is shorter than the length of a time-series audio signal. Therefore, a smaller model may be used as the model for the audio signal synthesizer 400. This may increase the efficiency of signal synthesis.

The frequency characteristic generated by the audio frequency characteristic generator 300 may have various forms. For example, the audio frequency characteristic generator 300 may use an STFT signal in the complex domain to restore a time-series audio signal without loss. In this case, the audio signal synthesizer 400 may perform the inverse Fourier transform to restore the time-series audio signal. The audio signal synthesizer 400 may perform the same functional role as a neural-vocoder in the field of speech synthesis. The audio frequency characteristic generator 300 may restore lost frequency characteristic information and phase information to complete the time-series audio signal.

In another embodiment, the audio frequency characteristic generator 300 may separately train a trainable filter and extract a frequency characteristic by using the filter. In this case, the frequency characteristic generator 300 and the audio signal synthesizer 400 may be trained as a type of autoencoder, and only a decoder part may be used in a generation process. Hereinafter, the structure of each functional block will be described in detail.

The audio signal processing device may use any text encoder model that is pre-trained as a text encoder. For example, the text encoder may be a Flan-T5 model based on a transformer structure. The Flan-T5 model is an instruction-finetuned version of a T5 model, which is a widely known language model, and may be actively used not only for addressing various text-based problems, but also for text-based image generation or audio generation.

The first generator of the audio frequency characteristic generator 300 may be a model based on an diffusion probabilistic model. The diffusion probabilistic model may be described in terms of two processes. The processing by the diffusion probabilistic model may be divided into a diffusion process for adding white noise to a data sample and a denoising process for removing the added white noise. The diffusion process may be performed only for model training, and during actual audio signal generation, only the denoising process may be performed. The denoising process is the inverse of the diffusion process and may be performed by training an internal neural network. When white noise, along with an appropriate conditioning input, is input into the trained diffusion probabilistic model, the audio frequency characteristic generator 300 may generate a data sample, i.e., an audio feature vector, through a gradual denoising process. Furthermore, the first generator may follow a UNet structure. The UNet structure may include a down-sampling layer for continuously reducing the size of data and an up-sampling layer for increasing the size of data again. Thus, the UNet structure may learn patterns of various resolutions within blocks. There may be a recurrent neural network between the down-sampling and up-sampling layers. The recurrent neural network may play a role of processing global information within the UNet. That is, the recurrent neural network may help maintain consistency by allowing different parts of the generated core frequency characteristic to refer to each other. Meanwhile, each of the down-sampling and up-sampling layers may include a convolutional neural network (CNN) layer and an attention layer. The convolutional neural network is configured to refer to more localized information, i.e., information between neighboring times or channels. These embodiments may produce a more consistent and natural frequency characteristic in neighboring time frames or channels. Unlike the previous two elements, the attention layer may be conditioned to ensure that a text feature vector obtained from user-input text is well reflected in an audio feature vector. An attentional mechanism within the attention layer may be used to calculate a weight that indicate how much an audio feature vector at a specific time and channel will refer to each part of the text feature vector. The audio frequency characteristic generator 300 may use the calculated weight and the text feature vector to calculate a weighted sum of the text feature vector. The audio frequency characteristic generator 300 may use the weighted sum to reflect the user-input text in the core frequency characteristic.

The second generator is structurally similar to the first generator. The second generator may use a separate attentional module for reflecting text information, even if the audio feature vector given as input already contains text information.

The audio signal synthesizer 400 may synthesize a time-series audio signal from an audio frequency characteristic. The audio signal synthesizer 400 may operate based on a generative adversarial network. To convert the generated audio frequency characteristic into a time-series audio signal, the audio signal synthesizer 400 may increase the dimension of the time axis and decrease the dimension of the frequency axis. A snake activation function may be used to suppress aliasing during this process. Unlike the neural vocoder of the speech synthesis system, which restores only a speech signal, the audio signal synthesizer 400 needs to generate more various types of audio signals. To this end, additional skip connections may be used to better propagate the context of a frequency characteristic to higher layers, allowing for better understanding and preservation frequency context. Furthermore, the audio signal synthesizer 400 enables efficient propagation by using feature-wise linear modulation (FiLM) for efficient reflection without the addition of parameters.

FIGS. 4 and 5 illustrate a process of training an audio signal processing device according to embodiments of the present disclosure.

In order for the audio signal processing device to be trained, input modal for describing an audio signal and audio feature information indicating features of an audio signal are required. The audio feature information may include one of quality reference information indicating the quality of an audio signal to be generated, recording environment information indicating a recording environment, or background sound information indicating whether the audio signal to be generated is background sound. The quality reference information may include a sampling frequency of the audio signal. A modal encoder may process the input modal and the audio feature information together. The audio feature information may be converted to text. Furthermore, the modal encoder may combine, with the input modal, a label indicating audio feature information of a group to which the input modal belongs. For example, the modal encoder may concatenate audio feature information to a token of the input model. As described above, the label may have a text form. Furthermore, the group may be classified based on audio feature information. The modal encoder may convert the label and the input modal into separate feature vector sequences. Each of the converted feature vector sequences may be concatenated and used as an input into an audio frequency generator. Furthermore, the modal encoder may convert the concatenated label and modal information into a single feature vector sequence. A feature vector is input into the audio frequency generator.

Furthermore, when the trained audio signal processing device generates an audio signal, the audio signal processing device may fix the quality reference information to a predetermined quality. The pre-fixed quality may be the highest quality among predefined qualities. In another specific embodiment, the pre-fixed quality may be equal to or higher than a predetermined reference. This is because at the time of training of a generative model, audio signals of various qualities are generated to improve the accuracy of the generation, but at the time of actual audio generation, providing high-quality audio signals may increase user satisfaction.

A first audio frequency characteristic generator, a second audio frequency characteristic generator, and an audio signal synthesizer in the audio frequency characteristic generator may all be trained individually and in parallel. FIG. 4 illustrates an example of a machine learning device being trained in parallel according to an embodiment of the present disclosure. Furthermore, the first audio frequency characteristic generator, the second audio frequency characteristic generator, and the audio signal synthesizer may be trained in series for organic operation of the audio signal processing device. FIG. 5 illustrates an example of a machine learning device being trained in series according to an embodiment of the present disclosure. The first audio frequency characteristic generator, the second audio frequency characteristic generator, and the audio signal synthesizer are each trained to generate a frequency characteristic or audio signal to be generated from a given input, thereby reducing a loss value of a loss function with respect to the original frequency characteristic or audio signal. The loss function may be MAE or MSE, which are widely used in neural network models. In another specific embodiment, a multi-resolution STFT loss function used in the audio field may be used as the loss function.

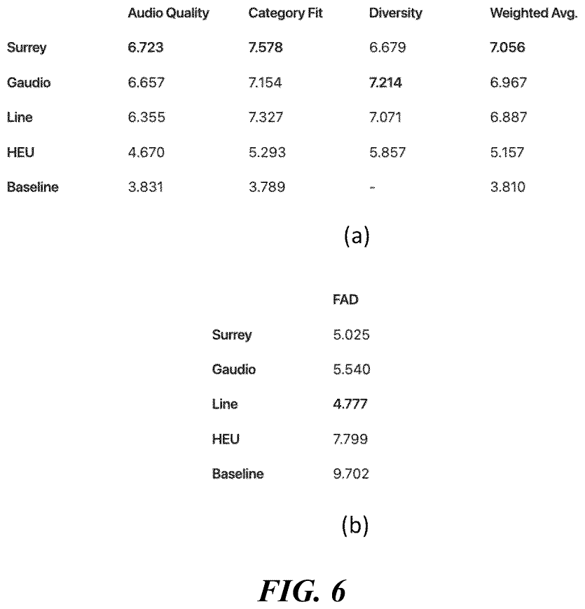

FIG. 6 illustrates the results of evaluating the performance of an audio signal processing device trained according to an embodiment of the present disclosure.

Publicly available audio data was used for the training of the audio signal processing device described above. Specifically, Audioset(https://research.google.com/audioset/), clotho2(https://zenodo.org/records/3490684), FSD50k(https://zenodo.org/records/4060432#.Y3cpsOxByDU), and sonniss—GDC Game Audio Bundles(https://sonniss.com/gameaudiogdc) were used.

FIG. 6 shows the results of evaluation performed according to the evaluation method of the 2023 challenge organized by Detection and Classification of Acoustic Scenes and Events (DCASE). “Audio Quality” in (a) of FIG. 6 is a sound evaluation item. “Category Fit” in (b) of FIG. 6 is an item for evaluating whether the generated content fits a user input. “Diversity” is an item for evaluating how many various sounds may be generated within one category. “Weighted Avg” is a comprehensive evaluation item, and represents a score obtained by computing weighted average of scores of “Audio Quality”, “Category Fit”, and “Diversity” in a 2:2:1 ratio. In addition, (b) of FIG. 6 shows Frechet Audio Distance (FAD) scores, which are used as evaluation metrics for a GAN for generating audio. A lower FAD score indicates higher performance. As illustrated in (a) and (b) of FIG. 6, it can be identified that a model (GAUDIO) according to an embodiment of the disclosure outperforms the existing models.

Some embodiments may also be implemented in the form of a recording medium including computer-executable instructions, such as a program module executable by a computer. A computer-readable medium may be any available medium that is accessible by a computer, and may include both volatile and non-volatile media and both detachable and non-detachable media. Further, the computer-readable medium may include a computer storage medium. The computer storage medium may include both volatile and non-volatile and both detachable and non-detachable media, which are implemented in any method or technology for storing information, such as computer-readable instructions, data structures, program modules, or other data.

The present disclosure has been described above with specific embodiments, but those skilled in the art to which the present disclosure belongs may make modifications and changes without departing from the spirit and scope of the present disclosure. In other words, although the present disclosure has been described with respect to an embodiment of audio signal generation, the present disclosure is equally applicable and extensible to various multimedia signals including a video signal as well as an audio signal. Therefore, it is interpreted that anything easily inferable by those skilled in the art to which the present disclosure belongs from the detailed description and the embodiments of the present disclosure falls within the scope of the claims of the present disclosure.

1. An audio signal processing device for generating an audio signal for an input modal, the audio signal processing device comprising a processor,
wherein the processor is configured to:
acquire a label indicating a feature of a group to which the input modal belongs;
concatenate the acquired label to the input modal; and
input the input modal and the acquired label into a generative model to generate an audio signal.

2. The audio signal processing device of claim 1, wherein the label has a text form.

3. The audio signal processing device of claim 1, wherein the processor is configured to, in case that the audio signal processing device receives multiple input modals, independently concatenate a label corresponding to each of the multiple input modals to each of the multiple input modals.

4. The audio signal processing device of claim 1, wherein the label is text indicating the feature of the group indicated by the label.

5. The audio signal processing device of claim 1, wherein the feature of the group indicated by the label comprises at least one among quality reference information indicating a quality of the audio signal to be generated, recording environment information indicating a recording environment, or background sound information indicating whether the audio signal to be generated is background sound.

6. The audio signal processing device of claim 1, wherein the feature of the group indicated by the label comprises quality reference information,
the processor is configured to generate the audio signal by fixing the quality reference information to a predetermined quality, and
the generative model is trained using not only the predetermined quality, but also quality reference information indicating a quality other than the predetermined quality.

7. The audio signal processing device of claim 1, wherein the input modal comprises at least one among text indicating a category, text, text inferred from an image, or text inferred from a video.

8. The audio signal processing device of claim 1, wherein the generative model is configured to:
acquire tokens from the input modal and the label;
generate a feature vector from the acquired tokens;
generate an audio frequency characteristic from the feature vector; and
synthesize an audio signal from the generated audio frequency characteristic.

9. The audio signal processing device of claim 8, wherein the generative model is configured to generate a first audio frequency characteristic, and generate, as the audio frequency characteristic, a second audio signal frequency characteristic having a higher resolution in at least one of a time axis or a frequency axis than the first audio frequency characteristic.

10. The audio signal processing device of claim 8, wherein skip connections and FiLM are used when the generative model generates an audio frequency characteristic from the feature vector and synthesizes an audio signal from the generated audio frequency characteristic.

11. A training method for an audio signal processing device for generating an audio signal for an input modal, wherein the audio signal processing device is trained to:
acquire a label indicating a feature of a group to which the input modal belongs;
concatenate the acquired label to the input modal; and
input the input modal and the acquired label into a generative model to generate an audio signal.

12. The training method of 11, wherein the label has a text form.

13. The training method of 12, wherein the audio signal processing device is configured to, in case that the audio signal processing device receives multiple input modals, independently concatenate a label corresponding to each of the multiple input modals to each of the multiple input modals.

14. The training method of 11, wherein the label is text indicating the feature of the group indicated by the label.

15. The training method of 11, wherein the feature of the group indicated by the label comprises at least one among quality reference information indicating a quality of the audio signal to be generated, recording environment information indicating a recording environment, or background sound information indicating whether the audio signal to be generated is background sound.

16. The training method of 11, wherein the feature of the group indicated by the label comprises quality reference information,
the generative model is trained using not only a predetermined quality, but also quality reference information indicating a quality other than the predetermined quality, and
the audio signal processing device is configured to, when the audio signal processing device generates an audio signal after the training, generate the audio signal by fixing the quality reference information to the predetermined quality.

17. The training method of 11, wherein the input modal comprises at least one among text indicating a category, text, text inferred from an image, or text inferred from a video.

18. The training method of 11, wherein the generative model is configured to:
acquire tokens from the input modal and the label;
generate a feature vector from the acquired tokens;
generate an audio frequency characteristic from the feature vector; and
synthesize an audio signal from the generated audio frequency characteristic.

19. The training method of 18, wherein the generative model is configured to generate a first audio frequency characteristic, and generate, as the audio frequency characteristic, a second audio signal frequency characteristic having a higher resolution in at least one of a time axis or a frequency axis than the first audio frequency characteristic.

20. The training method of 18, wherein skip connections and FiLM are used when the generative model generates an audio frequency characteristic from the feature vector and synthesizes an audio signal from the generated audio frequency characteristic.
